(19) United States
(12) Patent Application Publication
(10) Pub. No.: US 2022/0111869 A1
(43) Pub. Date: Apr. 14, 2022

(54) INDOOR SCENE UNDERSTANDING FROM SINGLE-PERSPECTIVE IMAGES

(71) Applicant: NEC Laboratories America, Inc., Princeton, NJ (US)

(72) Inventors: Buyu Liu, Cupertino, CA (US); Pan Ji, San Jose, CA (US); Bingbing Zhuang, San Jose, CA (US); Manmohan Chandraker, Santa Clara, CA (US); Uday Kusupati, Lausanne (CH)

(21) Appl. No.: 17/494,927

(22) Filed: Oct. 6, 2021

Related U.S. Application Data
(60) Provisional application No. 63/089,058, filed on Oct. 8, 2020.

(51) Int. Cl. B60W 60/00; G06T 7/50; G06K 9/72; G06T 7/10; G06K 9/00; G06K 9/62; G06T 7/70; G06N 3/04; G06N 3/08

(52) U.S. Cl. CPC B60W 60/0015; G06T 7/50; G06K 9/726; G06T 7/10; G06K 9/00664; G06K 9/6256; B60W 2420/42; G06K 9/00979; G06N 3/04; G06N 3/08; G06T 2207/20081; G06T 2207/20084; B60W 2554/80; G06T 7/70

(57) ABSTRACT

Methods and systems for determining a path include detecting objects within a perspective image that shows a scene. Depth is predicted within the perspective image. Semantic segmentation is performed on the perspective image. An attention map is generated using the detected objects and the predicted depth. A refined top-down view of the scene is generated using the predicted depth and the semantic segmentation. A parametric top-down representation of the scene is determined using a relational graph model. A path through the scene is determined using the parametric top-down representation.

### RELATED APPLICATION INFORMATION

This application claims priority to 63/089,058, filed on Oct. 8, 2020, incorporated herein by reference in its entirety.

### BACKGROUND

### Technical Field

The present invention relates to computer vision, and, more particularly, to identifying human-interpretable representations of indoor scenes.

### Description of the Related Art

When viewing a scene from a single perspective, a computer vision system has only two dimensions of information to work with. It is difficult to determine the relationships between objects, due to depth and occlusion.

### SUMMARY

A method for determining a path includes detecting objects within a perspective image that shows a scene. Depth is predicted within the perspective image. Semantic segmentation is performed on the perspective image. An attention map is generated using the detected objects and the predicted depth. A refined top-down view of the scene is generated using the predicted depth and the semantic segmentation. A parametric top-down representation of the scene is determined using a relational graph model. A path through the scene is determined using the parametric top-down representation.

A method for determining a path includes detecting objects within a perspective image that shows a scene. Depth is predicted within the perspective image. Semantic segmentation is performed on the perspective image. An attention map is generated using the detected objects and the predicted depth. An initial top-down view of the scene is generated by projecting pixels of the perspective image into a three-dimensional space using the predicted depth. A refined top-down view of the scene is generated using the initial top-down view by extrapolating from the projected pixels and using the semantic segmentation to provide a complete semantic top-down view of the scene. A relational graph representation of the scene is generated, using the refined top-down view and the attention map. A parametric top-down representation of the scene is determined using the relational graph representation as input to a relational graph neural network model. A path through the scene is determined using the parametric top-down representation. The scene is navigated using the determined path.

A system for determining a path includes a hardware processor and a memory that stores a computer program. When executed by the hardware processor, the computer program causes the hardware processor to detect objects within a perspective image that shows a scene, to predict depth within the perspective image, to perform semantic segmentation on the perspective image, to generate attention map using the detected objects and the predicted depth, to generate refined top-down view of the scene using the predicted depth and the semantic segmentation, to determine a parametric top-down representation of the scene using a relational graph model, and to determine a path through the scene using the parametric top-down representation.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a perspective view of an interior scene, depicting objects and layout elements, in accordance with an embodiment of the present invention;

FIG. 2 is a block diagram illustrating the generation of a top-down parametric representation of a scene, using a variety of different machine learning models, in accordance with an embodiment of the present invention;

FIG. 3 is a block/flow diagram of a method for training a model to generate a top-down parametric representation of a scene, in accordance with an embodiment of the present invention;

FIG. 4 is a block/flow diagram of a method for navigating through a scene in accordance with an embodiment of the present invention;

FIG. 5 is a diagram of a top-down view of a scene, showing the determination of a path through the scene, in accordance with an embodiment of the present invention;

FIG. 6 is a block diagram of a computing device that may be configured to generate a top-down parametric representation of a scene, in accordance with an embodiment of the present invention;

FIG. 7 is a block diagram of a software program for generating a top-down parametric representation of a scene, in accordance with an embodiment of the present invention;

FIG. 8 is a diagram of a neural network model, in accordance with an embodiment of the present invention; and

FIG. 9 is a diagram of a deep neural network model, in accordance with an embodiment of the present invention.

### DETAILED DESCRIPTION OF PREFERRED EMBODIMENTS

To provide geometrically complete, human-interpretable representations of indoor scenes, a room layout with object locations may be generated from a perspective image from a monocular camera. The representation may be a top-view in parametric form, with each object layout in the top view being represented as an oriented bounding box.

The perspective image may be mapped to a semantic top-view map, as well as an attention map to handle occlusion relationships, using machine learning. In particular, end-to-end semi-supervised machine learning may use real images for training, as well as simulated top-view semantic maps. Multiple relationships may be modeled with a graph neural network (GNN), including object-object relationships and object-layout relationships, providing parametric predictions for both layouts and objects in the top-view.

Illustrative embodiments may simulate semantically and geometrically consistent top-view semantic maps. Based on these, more diverse layouts can be learned. The model may take a perspective image as an input and learn to predict the top-view semantic map as an intermediate representation, as well as predicting an attention map to focus on interesting regions.

Thus, for each perspective image from an indoor scene, the room layout and object locations may be predicted in parametric form. The parametric representation for room layout may include a number of walls, as well as their locations and orientations, and objects may be represented with their oriented bounding boxes. The end-to-end model learns to predict the top-view map on a pixel-level, handling occlusions. Appearance features may also be incorporated in a perspective view. By using both real and simulated training data, the model can be trained to generalize to diverse and rare cases.

Such a top-down map of an interior space can be used, for example, to aid in subsequent navigation by a robot or other autonomous device. By identifying the relationships between objects and the boundaries of the space, such a robot can more easily maneuver through the space. This is advantageous in circumstances where the robot has only a single camera, as unoccupied space can be identified for finding paths.

A parametric representation may list the features of the space. For example, the layout of the space may be defined according to boundaries (e.g., walls), including the locations and orientations of the walls. Objects within the space may be labeled according to their semantic meaning (e.g., “chair,” “bed,” or, “table”) as well as by the oriented bounding box that represents the space they occupy.

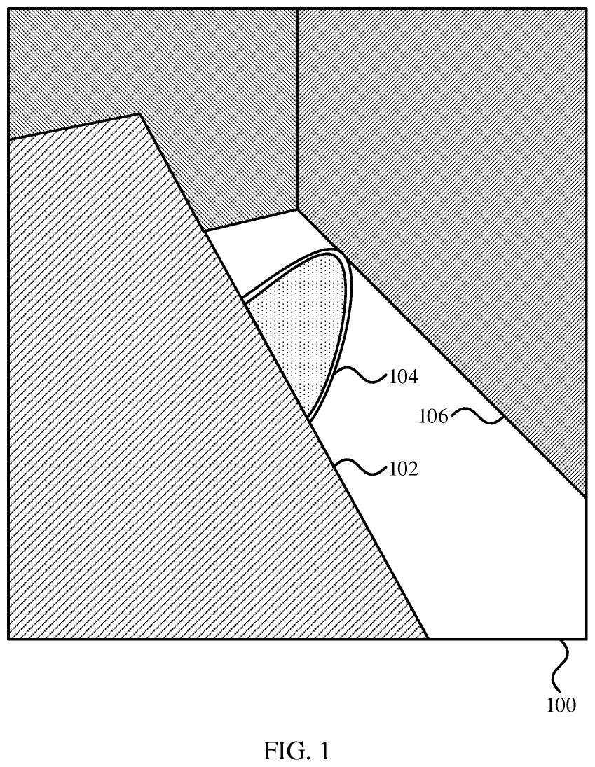

Referring now in detail to the figures in which like numerals represent the same or similar elements and initially to FIG. 1, an exemplary image 100 is shown. The image 100 includes a view of an interior scene, with a table 102 partially occluding the view of a chair 104. Also shown are objects like walls 106 and the floor, which may be partially occluded by foreground objects. The walls 106 may be considered background surfaces, while the table 102 and the chair 104 may be considered as being part of the foreground.

A parametric representation of this image may include information such as:

Number of walls: 2

Wall 1 center: <coordinates>

Wall 1 normal: <vector>

Wall 2 center: <coordinates>

Wall 2 normal: <vector>

Number of tables: 1

Location of table: <oriented bounding box>

Number of chairs: 1

Location of chair: <oriented bounding box>

Thus, given the perspective image of FIG. 1, a semantic segmentation may be obtained, along with depth and two-dimensional object detection. A model may be used to obtain the top-view schematic map and an attention map with the object detection and depth. A refinement network may be used to generate a more representative top-down map that recovers occlusion relations. Given the top-view semantic map, the room layout can be estimated. Using the top-view attention map as well as two-dimensional appearance features from the perspective view, a graph neural network models multiple relations between objects, such as adjacency, proximity, distance, and co-occurrence. The output of the graph neural network may be a parametric representation, such as the one described above.

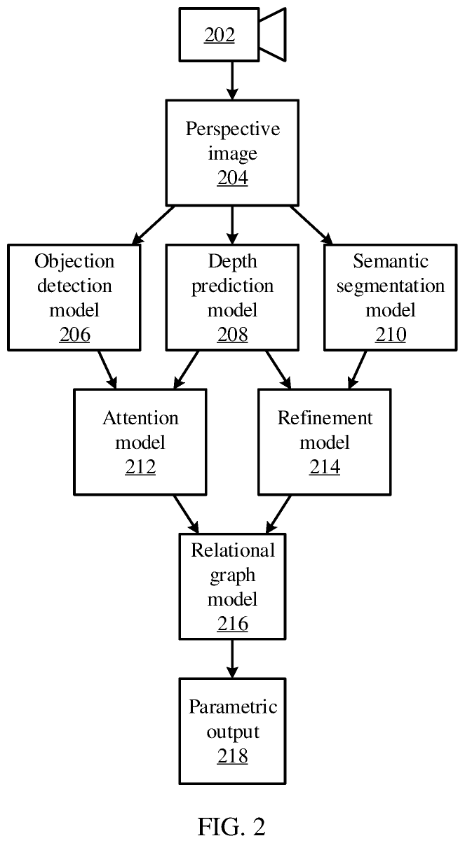

Referring now to FIG. 2, a diagram of a model for generating a parametric representation of a perspective image is shown. A camera 202 is used to capture a perspective image 204. The camera 202 may be any appropriate image capture device, for example including a monocular camera that captures a two-dimensional image. The perspective image 204 may include a view of an interior space, including a set of objects as well as layout features.

The perspective image 204 is processed by multiple different models to extract different kinds of information. For example, object detection model 206 is trained to identify objects within the perspective image 204, providing a label and a bounding box for each such object. Depth prediction model 208 is trained to identify the depths of each pixel in the perspective image 204, thereby helping to distinguish between objects that are near to the camera 202 and objects that are far from the camera 204. Semantic segmentation model 210 is trained to identify discrete objects and surfaces within the perspective image 204, for example identifying the difference between a table and an object sitting on the table.

Additional models process the outputs of the object detection model 206, the depth prediction model 208, and the semantic segmentation model 210. For example, attention model 212 is trained to use the outputs of the object detection model 206 and the depth prediction model 208 to generate a three-dimensional attention map, while refinement model 214 is trained to use the outputs of the depth prediction model 208 and the semantic segmentation model 210 to obtain the top-view semantic map.

When generating appearance features using the attention model 212, information from the object detection model 206 and the depth prediction model 208 is combined to identify the locations of objects within a three-dimensional space. The refinement model 214 creates a separate representation of the three-dimensional space that uses semantic segmentation to identify different surfaces, using the depth estimation model 208 to assign three-dimensional coordinates to the pixels of the perspective image 204 and using the segmentation model 210 to assign labels to those pixels. By projecting three-dimensional semantic information to a top-down view, an initial top-down view of the three-dimensional space can be generated, which may be populated relatively sparsely with pixels. This projection may take advantage of known camera parameters, which may help to map pixels in the perspective image 204 to three-dimensional space with three-dimensional geometry, for example by assigning [x, y, z] coordinates to each pixel. The per-pixel semantic map further associates each pixel with the semantic label to produce a three-dimensional semantic map.

The refinement model 214 may be trained to infer the remainder of the three-dimensional space. For example, the refinement model 214 may be trained using perspective images, or three-dimensional representations of such perspective images, along with complete top-down views of a same interior space as the perspective images and annotations in parametric form. The refinement model 214 may thus generate complete, occlusion-aware semantic top-down views that correspond to arbitrary new perspective images. A mapping is learned from the initial semantic map, which places the pixels of the perspective image 204 into a three-dimensional space, to the complete semantic top-view map.

Using the outputs of the attention model 212 and the refinement model 214, a relational graph model 216 uses, for example, a graph neural network to model the relations between different objects, as well as between the objects and features of the room layout. The relational graph model 216 outputs the parametric output 218, which may rely on an assumption that the use of a Cartesian grid for interior layouts leads to regularities in image edge gradient statistics. By modeling the relationships with graphs, consistent/coherent layout predictions may be generated. Thus, a relational graph may be generated for use as an input to the relational graph model 216, using spatial relationships identified in the refined top-down representation and attention information from the attention map.

The relational graph model 216 may operate in a manner similar to a convolutional neural network. Rather than being based on the proximity of pixels in a two-dimensional image, the relational graph model 216 regards objects within the interior scene as being related to one another by proximity in space or by semantic relationship. This information can be encoded using nodes and edges in a relational graph, where the nodes represent objects and layout elements, and where the edges represent relationships between such nodes. This information may be obtained from the refined top-view semantics, as well as from the attention map. For example, the attention map gives an estimation of the interior of a room, which can be bounded by the locations of walls. The edges may be defined between nodes, with distance-based relations being defined to indicate proximal and distant relations. Dense connections between objects may be introduced to model their co-occurrence relations as well.

GNN input feature may include the nodes and edges from the refined top-down view semantics, as well as appearance features from the perspective image 204, initial locations of layout elements and objects, and outputs of parametric predictions of both objects and layout elements from the perspective image 204.

Using the refined top-down view from the refinement model 214 and the initial map from the attention model 212, a set of features of the space may be generated, along with nodes and edges of the graph. The relational graph model 216 may thereby output the parametric representation 218, including a list of objects and layout features shown in the perspective image 204.

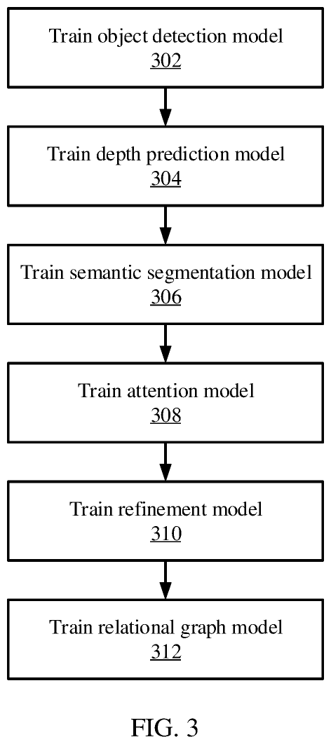

Referring now to FIG. 3, a method of training a system for generating a parametric representation of an indoor scene is shown. Each of the models in FIG. 2 may be trained separately, using different respective training information. For example, block 302 may train the object detection model 206 using a set of training images, each being labeled with any appropriate number of objects, including bounding boxes and semantic labels for each such object. This enables the object detection model 206 to detect the existence of various types of object, locate them within the input image, and generate specific location information.

Block 304 may train the depth prediction model 208. Depth prediction training information may include a set of training images, with each such training image having depth information for each of the pixels that make up the image. Based on this, the depth prediction model 208 can identify depth values associated with each of the pixels of an input image.

Block 306 may train the semantic segmentation model 210. Semantic segmentation training information may include a set of training images, with each training image having different surfaces or objects within the scene be labeled according to some appropriate annotation scheme. For example, some objects may be layout objects, such as walls, while other objects may be interior objects, such as pieces of furniture. Each such object may be further broken down into different semantic sub-categories. For example, a chair may have a seat surface, legs, and a back, and each may have a different associated semantic labeling.

Block 308 may train the attention model 212. The attention model training information may include a set of training images, with each training image being labeled according to objects and pixel depth. The attention model 212 may be trained to accept objects and pixel depths from a perspective image 204 and output an attention map of the space, with objects being labeled according to the distances of their center locations from the camera 202.

Block 310 may train the refinement model 216. The refinement model training information may include training images which are associated with corresponding top-down views of a same interior scene. The refinement model may thereby be trained to fill in spaces in the top-down view which are not directly provided by the depth-enhanced pixels of the perspective image 204. This refinement may make use of semantic information from the semantic segmentation model 306, thereby taking advantage of knowledge about the structure of certain common objects. For example, if a bed is detected in the image, this information can be used to indicate general proportions and sizes of beds within the output top-down view.

Block 312 may train the relational graph model 218. The relational graph training information may include information about the top-down view of an interior scene, along with a corresponding attention map that provides positional relationship image from a perspective view of the same scene, and may generate a parametric representation of the top-down view, with each node in the graph corresponding to a respective object or layout element in the scene.

In some cases, certain models may be trained in tandem, or in an end-to-end fashion. In other cases, the models may be trained separately, using different respective sets of training data. Training data may be generated that includes a known top-down view for a respective perspective image, which can be used to train the various models to improve the accuracy of the parametric representation predictions. Simulated training data may further be used. Given arbitrary parametric annotations, a semantic top-down view may be generated using a renderer. A graph and attention map can further be generated suing the parametric annotation. Appearance features can then be sampled to associate them with the semantic labels, as well as determining a distance from the simulated camera. This data can be used to supplement original training data, thereby improving the generality and robustness of the trained models.

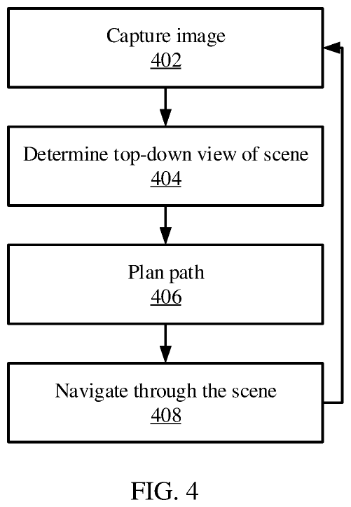

Referring now to FIG. 4, a method of navigating through an interior environment is shown. Block 402 captures a perspective image 204 using a camera 202. For example, the camera 202 may be in a fixed location within the environment, or it may be mobile. Examples of mobile cameras may include cameras that are carried by a human being and cameras that are carried by, or installed on, an autonomous vehicle or device, such as a robot.

Block 404 determines a top-down view of the scene illustrated in the perspective image 204, for example generating a parametric representation of objects and layout elements within the scene, as described above. Block 406 then plans a path through the environment. This path may be planned to avoid collision with objects that have been detected within the scene, and may take into account areas of the environment that were not visible within the perspective, but which were inferred in block 404. Block 408 then navigates through the environment, for example by providing instructions to the person holding the phone or by causing the autonomous vehicle or device to maneuver around objects in the environment. The path may be updated after moving within the environment by returning to block 402 to capture a new perspective image 204.

Although the parametric top-down representation is described in the specific context of navigating through a space, it should be understood that the top-down representation may be used for any appropriate application. Thus, planning a path through the environment and navigating through the environment are optional.

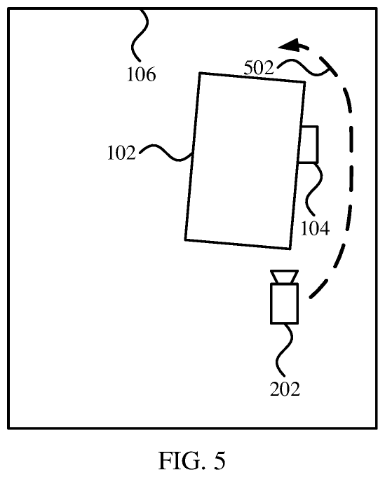

Referring now to FIG. 5, an exemplary top-down view is shown, which may correspond to the perspective image shown in FIG. 1. The camera 202 is shown in the context of the detected objects, including table 102 and chair 104, shown relation to walls 106. A path 502 is shown, which may be used to navigate through the environment, around the detected objects.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

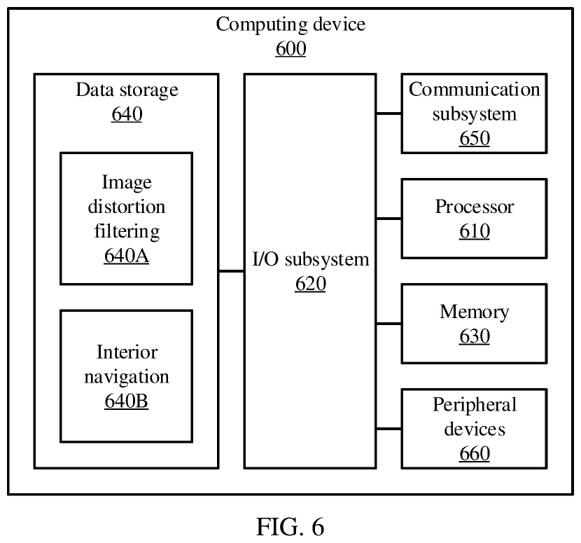

FIG. 6 is a block diagram showing an exemplary computing device 600, in accordance with an embodiment of the present invention. The computing device 600 is configured to identify a top-down parametric representation of an indoor scene and provide navigation through the scene.

The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as a one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for generating a parametric top-down representation of a perspective image and program code 640B for navigating within a scene based on the representation. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

These and other variations of a hardware processor subsystem are also contemplated in accordance with embodiments of the present invention.

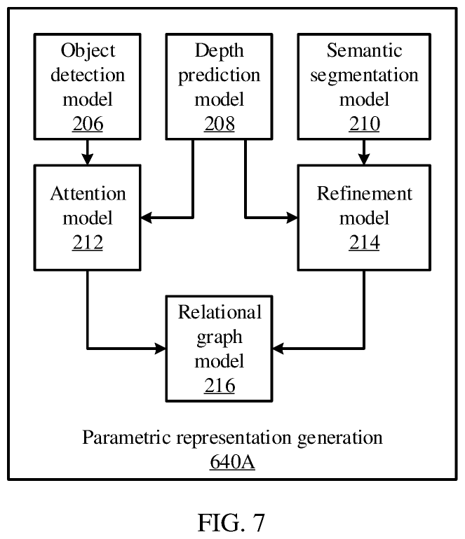

Referring now to FIG. 7, additional detail on the parametric representation generation 640A is shown. The different models, described above with respect to FIG. 2, may be implemented in software in this fashion. For example, these models may be implemented as neural network models, but it should be understood that any other appropriate machine learning technique may be used instead.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

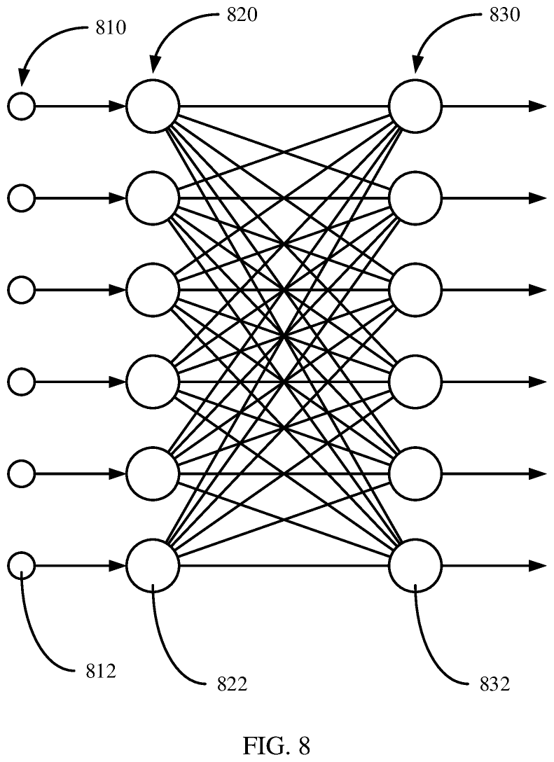

Referring now to FIG. 8, an exemplary neural network architecture is shown. In layered neural networks, nodes are arranged in the form of layers. A simple neural network has an input layer 820 of source nodes 822, a single computation layer 830 having one or more computation nodes 832 that also act as output nodes, where there is a single node 832 for each possible category into which the input example could be classified. An input layer 820 can have a number of source nodes 822 equal to the number of data values 812 in the input data 810. The data values 812 in the input data 810 can be represented as a column vector. Each computational node 830 in the computation layer generates a linear combination of weighted values from the input data 810 fed into input nodes 820, and applies a non-linear activation function that is differentiable to the sum. The simple neural network can perform classification on linearly separable examples (e.g., patterns).

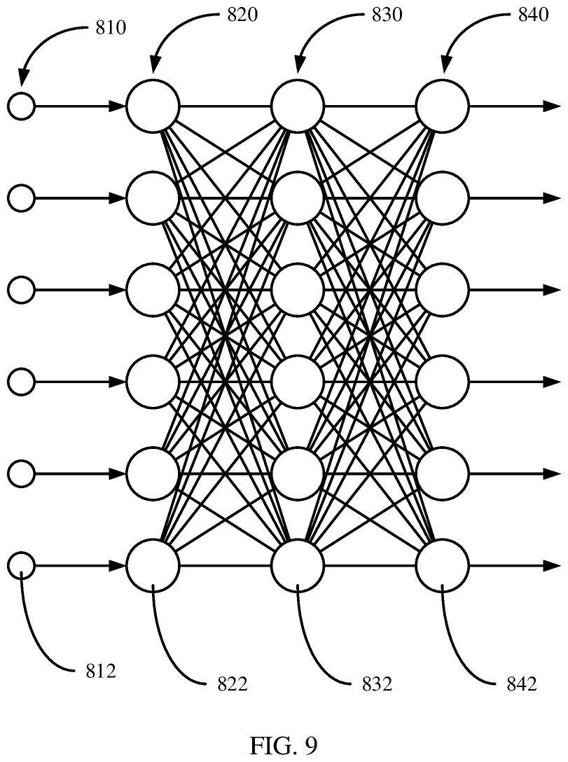

Referring now to FIG. 9, a deep neural network architecture is shown. A deep neural network, also referred to as a multilayer perceptron, has an input layer 820 of source nodes 822, one or more computation layer(s) 830 having one or more computation nodes 832, and an output layer 840, where there is a single output node 842 for each possible category into which the input example could be classified. An input layer 820 can have a number of source nodes 822 equal to the number of data values 812 in the input data 810. The computation nodes 832 in the computation layer(s) 830 can also be referred to as hidden layers because they are between the source nodes 822 and output node(s) 842 and not directly observed. Each node 832, 842 in a computation layer generates a linear combination of weighted values from the values output from the nodes in a previous layer, and applies a non-linear activation function that is differentiable to the sum. The weights applied to the value from each previous node can be denoted, for example, by w₁, W₂, wₙ₋₁ wₙ. The output layer provides the overall response of the network to the inputted data. A deep neural network can be fully connected, where each node in a computational layer is connected to all other nodes in the previous layer. If links between nodes are missing the network is referred to as partially connected.

Training a deep neural network can involve two phases, a forward phase where the weights of each node are fixed and the input propagates through the network, and a backwards phase where an error value is propagated backwards through the network.

The computation nodes 832 in the one or more computation (hidden) layer(s) 830 perform a nonlinear transformation on the input data 812 that generates a feature space. The feature space the classes or categories may be more easily separated than in the original data space.

The neural network architectures of FIGS. 8 and 9 may be used to implement, for example, any of the models shown in FIG. 2. To train a neural network, training data can be divided into a training set and a testing set. The training data includes pairs of an input and a known output. During training, the inputs of the training set are fed into the neural network using feed-forward propagation. After each input, the output of the neural network is compared to the respective known output. Discrepancies between the output of the neural network and the known output that is associated with that particular input are used to generate an error value, which may be backpropagated through the neural network, after which the weight values of the neural network may be updated. This process continues until the pairs in the training set are exhausted.

After the training has been completed, the neural network may be tested against the testing set, to ensure that the training has not resulted in overfitting. If the neural network can generalize to new inputs, beyond those which it was already trained on, then it is ready for use. If the neural network does not accurately reproduce the known outputs of the testing set, then additional training data may be needed, or hyperparameters of the neural network may need to be adjusted.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for determining a path, comprising:
detecting objects within a perspective image that shows a scene;
predicting depth within the perspective image;
performing semantic segmentation on the perspective image;
generating an attention map using the detected objects and the predicted depth;
generating a refined top-down view of the scene using the predicted depth and the semantic segmentation;
determining a parametric top-down representation of the scene using a relational graph model; and
determining a path through the scene using the parametric top-down representation.

2. The method of claim 1, further comprising navigating through the scene using the determined path.

3. The method of claim 2, further comprising repeating the detection of objects within a new perspective image, predicting depth within the new perspective image, performing semantic segmentation on the new perspective image, generating an attention map using the detected objects and the predicted depth from the new perspective image, generating a refined top-down view of the scene using the predicted depth and the semantic segmentation from the new perspective image, and determining a parametric top-down representation of the scene using the relational graph model after navigating through the scene.

4. The method of claim 1, wherein the relational graph model is implemented as a neural network model.

5. The method of claim 1, further comprising training the relational graph model using training data that includes parametric top-down representations of scenes and associated attention maps.

6. The method of claim 1, wherein generating the refined top-down view of the scene includes generating an initial top-down view by projecting pixels of the perspective image into a three-dimensional space using the predicted depth.

7. The method of claim 6, wherein generating the refined top-down view of the scene includes extrapolating from the projected pixels and semantic labels for each of the projected pixels in the initial top-down view to provide a complete semantic top-down view of the scene.

8. The method of claim 1, wherein determining the parametric top-down representation includes generating a relational graph representation of the scene, using the refined top-down view and the attention map, for use as an input to the relational graph model.

9. The method of claim 1, wherein the parametric top-down representation includes coordinates and orientation information for objects and layout elements in the scene.

10. The method of claim 1, further comprising capturing the perspective image using a monocular camera on an autonomous vehicle.

11. A method for determining a path, comprising:
detecting objects within a perspective image that shows a scene;
predicting depth within the perspective image;
performing semantic segmentation on the perspective image;
generating an attention map using the detected objects and the predicted depth;
generating an initial top-down view of the scene by projecting pixels of the perspective image into a three-dimensional space using the predicted depth;
generating a refined top-down view of the scene using the initial top-down view by extrapolating from the projected pixels and using the semantic segmentation to provide a complete semantic top-down view of the scene;
determining a relational graph representation of the scene, using the refined top-down view and the attention map;
determining a parametric top-down representation of the scene using the relational graph representation as input to a relational graph neural network model;
determining a path through the scene using the parametric top-down representation; and
navigating through the scene using the determined path.

12. A system for determining a path, comprising:
a hardware processor; and
a memory that stores a computer program, which, when executed by the hardware processor, causes the hardware processor to:
detect objects within a perspective image that shows a scene;
predict depth within the perspective image;
perform semantic segmentation on the perspective image;
generate an attention map using the detected objects and the predicted depth;
generate a refined top-down view of the scene using the predicted depth and the semantic segmentation;
determine a parametric top-down representation of the scene using a relational graph model; and
determine a path through the scene using the parametric top-down representation.

13. The system of claim 12, wherein the computer program further causes the hardware process to navigate through the scene using the determined path.

14. The system of claim 13, wherein the computer program further causes the hardware processor to repeat the detection of objects within a new perspective image, the prediction of depth within the new perspective image, the semantic segmentation on the new perspective image, the generation of an attention map using the detected objects and the predicted depth from the new perspective image, the generation of a refined top-down view of the scene using the predicted depth and the semantic segmentation from the new perspective image, and the determination of a parametric top-down representation of the scene using the relational graph model after navigating through the scene.

15. The system of claim 12, wherein the relational graph model is implemented as a neural network model.

16. The system of claim 12, wherein the computer program further causes the hardware process to train the relational graph model using training data that includes parametric top-down representations of scenes and associated attention maps.

17. The system of claim 12, wherein the computer program further causes the hardware process to generate an initial top-down view by projecting pixels of the perspective image into a three-dimensional space using the predicted depth.

18. The system of claim 17, wherein the computer program further causes the hardware process to extrapolate from the projected pixels and semantic labels for each of the projected pixels in the initial top-down view to provide a complete semantic top-down view of the scene.

19. The system of claim 12, wherein the computer program further causes the hardware process to generate a relational graph representation of the scene, using the refined top-down view and the attention map, for use as an input to the relational graph model.

20. The system of claim 12, wherein the parametric top-down representation includes coordinates and orientation information for objects and layout elements in the scene.
